(19) United States
(12) Patent Application Publication
(10) Pub. No.: US 2008/0148697 A1
(43) Pub. Date: Jun. 26, 2008

(54) Filter for Nail Gun

(76) Inventors: Chia Sheng Liang, Bali Shiang (TW); Ming Tsang Jiang, (US)

Correspondence Address: Wen-Chin Hu, 4331 Stevens Battle Lane, Fairfax, VA, 22033, US

(21) Appl. No.: 11/614,059

(22) Filed: Dec. 20, 2006

(51) Int. Cl. B01D 27/00

(52) U.S. Cl. 55/482; 55/385.1

(57) ABSTRACT

A filter is disposed inside an air chamber in a handle of a nail gun and located close to the end of the handle to divide the air chamber into a front chamber and a rear chamber. A cover with a connector extended therefrom is fixed on the end of the handle and a plurality of protruding ribs are formed on the inner wall of the front chamber, so that the filter is fixed between the protruding ribs and the connector. The filter includes an inner plate formed with a plurality of through holes and disposed adjacent to the front chamber, an outer plate formed with a plurality of through hole and disposed adjacent to the rear chamber and connected with the inner plate, and at least one filter element fixed between the inner and the outer plates to filter particles of high pressure air introduced into the air chamber.

### BACKGROUND

The present invention relates to a filter, and particularly to a filter installed inside an air chamber of the handle of a nail gun for filtering particles in continuously loaded high pressure air.

Conventional pneumatic nail gun has an air chamber formed in a handle for continuously collecting air from an end of the handle so that high pressure air can be guided into a gun body of the nail gun as the power source. A filter is installed inside the air chamber of the handle for filtering the particles in the high pressure air.

The related arts, such as U.S. Pat. No. 5,259,465, U.S. Pat. No. 6,726,080 and US Pub. No. 20060086072 respectively disclose a filter installed inside the handle of the nail gun for filtering the particles in the high pressure air and a retainer, such as a positioning ring or a cover plate with plural air through hole, is selectively disposed at one side thereof to fix the filter element. Normally the filter element is made by soft cotton or non-woven fabric; since the above-mentioned retainer is merely disposed at one side of the filter element, under long-term action of the high pressure air, the single retainer can not prevent the soft filter element from distortion; therefore, the filter may not be used for a long time.

### BRIEF SUMMARY

The present invention provides a filter for a nail gun to avoid distortion, especially under long-term action of the high pressure air, so that the soft filter is more stable and endurable in use.

The filter is disposed inside an air chamber in a handle of the nail gun and located close to the end of the handle to divide the air chamber into a front chamber and a rear chamber. A cover with a connector extended therefrom is fixed on the end of the handle and a plurality of protruding ribs are formed on the inner wall of the front chamber, so that the filter is fixed between the protruding ribs and the connector. The filter includes an inner plate formed with a plurality of through holes and disposed adjacent to the front chamber, an outer plate formed with a plurality of through hole and disposed adjacent to the rear chamber and connected with the inner plate, and at least one filter element fixed between the inner and the outer plates to filter particles of high pressure air introduced into the air chamber.

Accordingly, when the high pressure air is introduced from a tube into the rear chamber via an air inlet formed in the cover, the high pressure air flows into the through holes of the outer plate and through the filter element so that particles in the high pressure air are filtered by the filter element. Thereafter, the high pressure air flows out from the through holes of the inner plate to be accumulated in the front chamber as the power for nail hitting operation of the nail gun. Meanwhile, the outer plate can endure the pushing force exerted by the high pressure air, and the inner plate is used to retain and protect the filter element. Furthermore, when the tube is removed after finishing use of the nail gun, the high pressure air in the chamber will be expelled from the front chamber, through the holes of the inner plate and the holes of the outer plate, to the rear chamber and out of the chamber through the air inlet to the environment. At this time, the inner plate can endure the pushing force exerted by the high pressure air, and the outer plate is used to retain and protect the filter element. Therefore, the high pressure air is not directly exerted on the filter element, so that the filter element can be avoided from distortion and be more stable and endurable in use to have longer life.

Moreover, an annular ring or a plurality of protrusions are formed on edge of the outer plate to engage with the inner plate. A holding portion may be further extended from the annular ring or each protrusion so that the inner and the outer plates are well engaged to securely fix the filter element therebetween.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a cross-sectional view of a filter in a handle of a nail gun according to a first embodiment of the present invention;

FIG. 2 is another cross-sectional view of the handle in FIG. 1;

FIG. 3 is an exploded perspective view of a filter for the nail gun in FIG. 1 according to a preferred embodiment;

FIG. 4a shows high pressure air flowing into an air chamber in the handle;

FIG. 4b shows the high pressure air flowing out of the air chamber;

FIG. 5 is a cross-sectional view of a filter in a handle of a nail gun according to a second embodiment of the present invention;

FIG. 6 is an exploded perspective view of a filter in FIG. 5 according to a preferred embodiment;

FIG. 7 is a cross-sectional view of a filter in a handle of a nail gun according to a third embodiment of the present invention;

FIG. 8 is a cross-sectional view of a filter in a handle of a nail gun according to a fourth embodiment of the present invention;

FIG. 9 is another cross-sectional view of the handle in FIG. 8;

FIG. 10 is an exploded perspective view of a filter in FIG. 8 according to a preferred embodiment;

FIG. 11 is a cross-sectional view of a filter in a handle of a nail gun according to a fifth embodiment of the present invention;

FIG. 12 is an exploded perspective view of a filter in FIG. 11 according to a preferred embodiment;

FIG. 13 is a cross-sectional view of a filter in a handle of a nail gun according to a sixth embodiment of the present invention.

### DETAILED DESCRIPTION

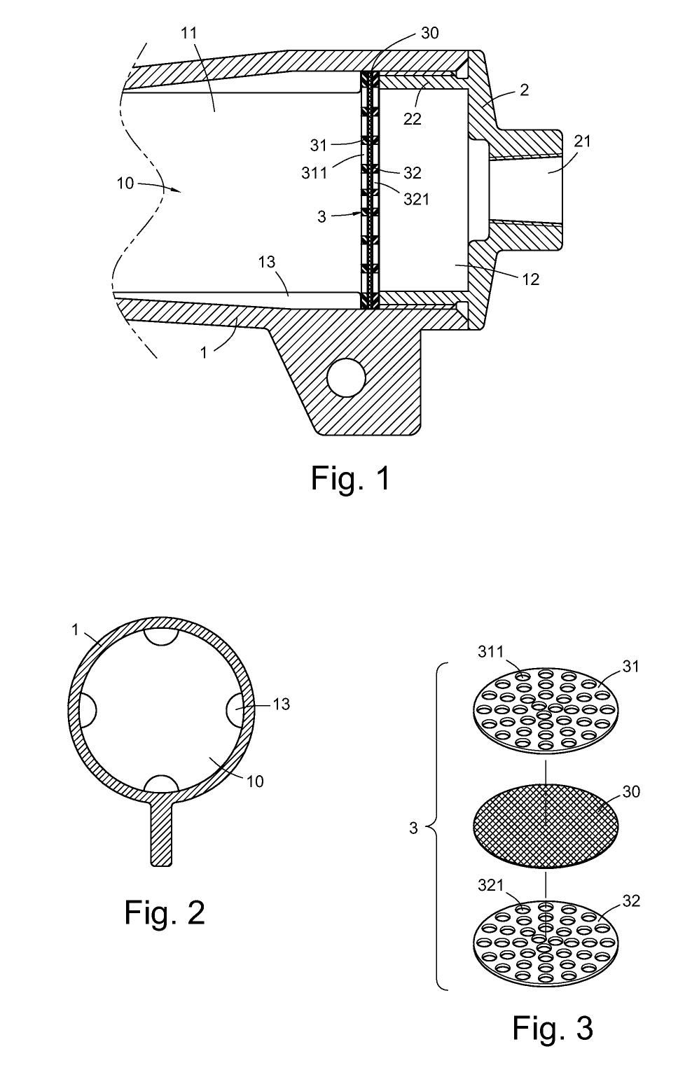

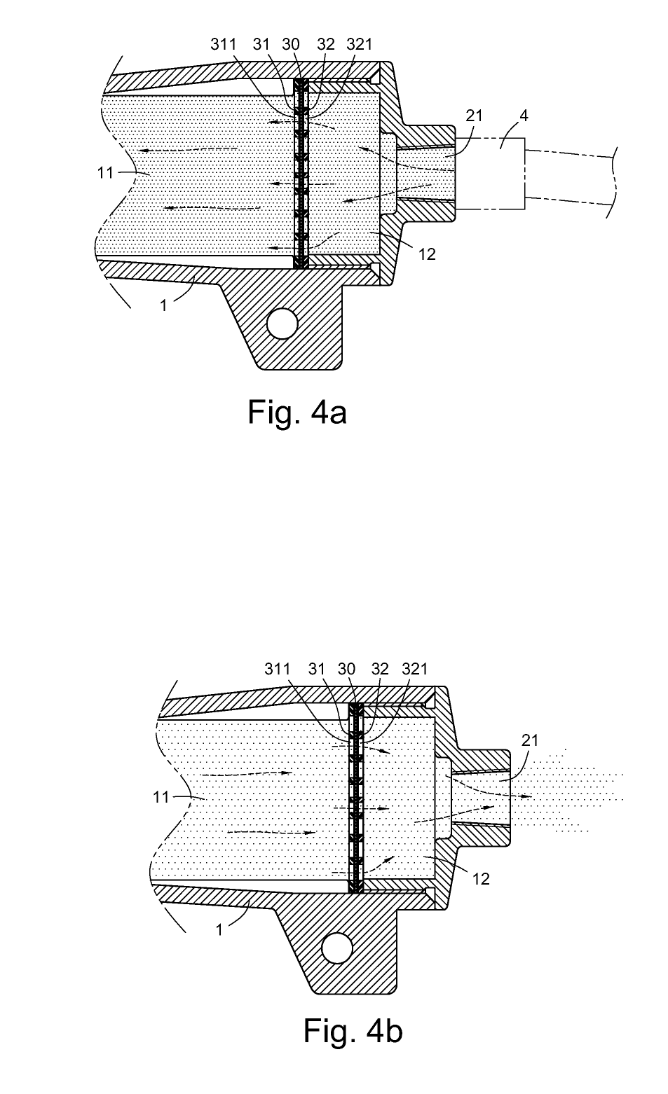

FIG. 1 shows a filter for a nail gun according to a preferred embodiment of the present invention. A filter 3 is disposed inside an air chamber 10 with a round cross section in a handle 1 of the nail gun. The air chamber 10 is divided into a front chamber 11 and a rear chamber 12 by the filter 3 and the filter 3 is located close to the end of the handle 1. A cover 2 is fixed on the end of the handle 1 and has an air inlet 21 formed therein to have a tube 4 (as shown in FIG. 4a) connected therein for supplying high pressure air to the rear chamber 12. Moreover, an annular connector 22 is extended from the cover 2 to be screwed to the end of the handle 1 in the rear chamber 12 and a plurality of protruding ribs 13 (referring together with FIG. 2) are formed on the inner wall of the front chamber 11, so that the filter 3 is fixed between the protruding ribs 13 and the annular connector 22.

The filter 3 includes an inner plate 31, an outer plate 32 and at least one filter element 30. The inner plate 31 with a plurality of through holes 311, referring together with FIG. 3, is disposed adjacent to the front chamber 11. The outer plate 32 with a plurality of through hole 321 is disposed adjacent to the rear chamber 12 and connected with the inner plate 31. Preferably one filter element 30 is used in the embodiment, which is normally made by soft stainless net, filtering cotton sheet, filtering paper sheet or non-woven fabric sheet, and is fixed between the inner and the outer plates 31 and 32.

As shown in FIG. 4a, when the high pressure air is introduced from the tube 4 into the rear chamber 12 of the handle 1 via the air inlet 21, the high pressure air flows into the through holes 321 of the outer plate 32 and through the filter element 30 so that particles in the high pressure air are filtered by the filter element 30. Thereafter, the high pressure air flows out from the through holes 311 of the inner plate 31 to be accumulated in the front chamber 11 as the power for nail hitting operation of the nail gun. Meanwhile, the outer plate 32 can endure the pushing force exerted by the high pressure air, and the inner plate 31 is used to retain and protect the filter element 30. Furthermore, as shown in FIG. 4b, when the tube 4 is removed after finishing use of the nail gun, the high pressure air in the chamber 10 will be expelled from the front chamber 11, through the holes 311 of the inner plate 31 and the holes 321 of the outer plate 32, to the rear chamber 12 and out of the chamber 10 through the air inlet 21 to the environment. At this time, the inner plate 31 can endure the pushing force exerted by the high pressure air, and the outer plate 32 is used to retain and protect the filter element 30. Therefore, the high pressure air is not directly exerted on the filter element 30, so that the filter element 30 can be avoided from distortion and be more stable and endurable in use to have longer life.

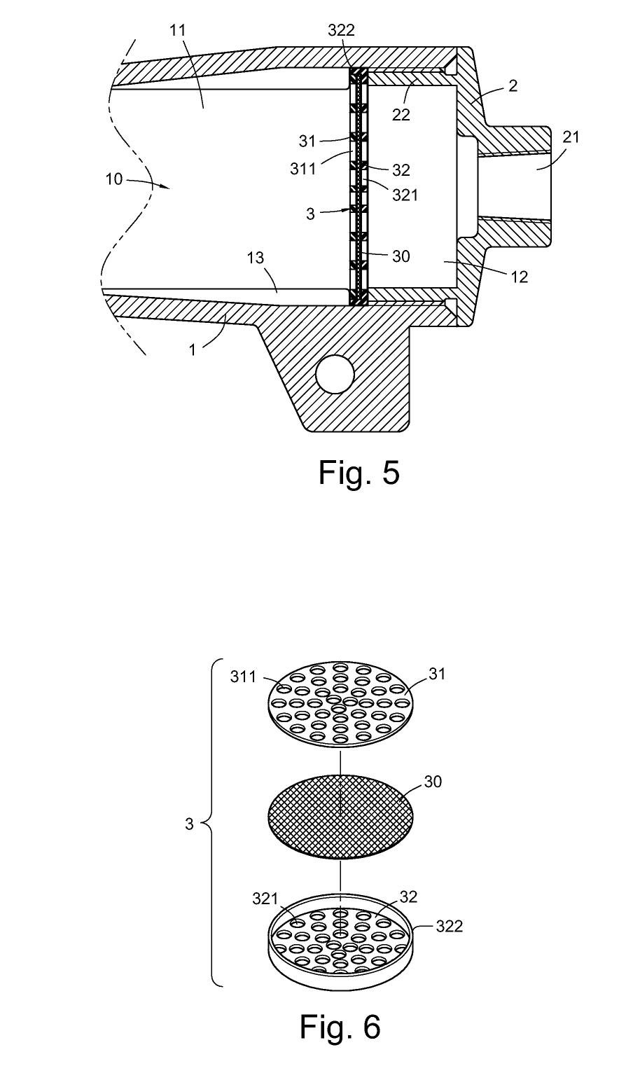

In another preferred embodiment, as shown in FIGS. 5 and 6, the outer plate 32 includes an annular ring 322 formed on the edge to engage with the inner plate 31. As such, the filter element 30 can be fixedly and stably located between the inner and the outer plates 31 and 32, and will not be wabble due to the high pressure air to be presented from distortion.

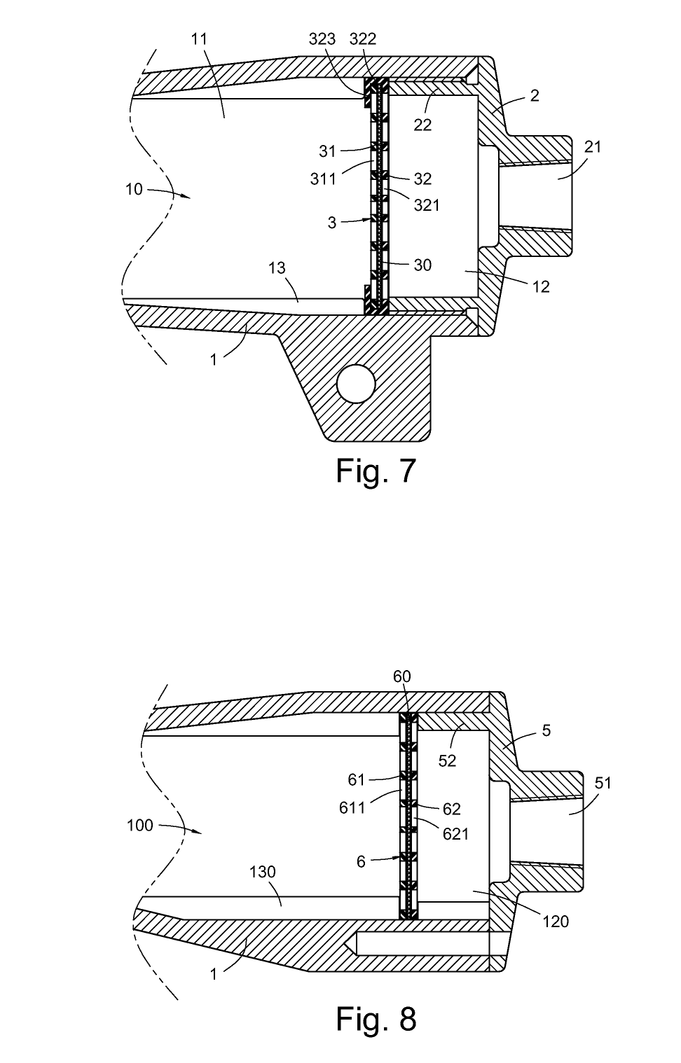

Moreover, as shown in FIG. 7, the annular ring 322 may further includes a holding portion 323 extended from the end; therefore the filter element 30 and the inner plate 31 can be more securely fixed in the outer plate 32.

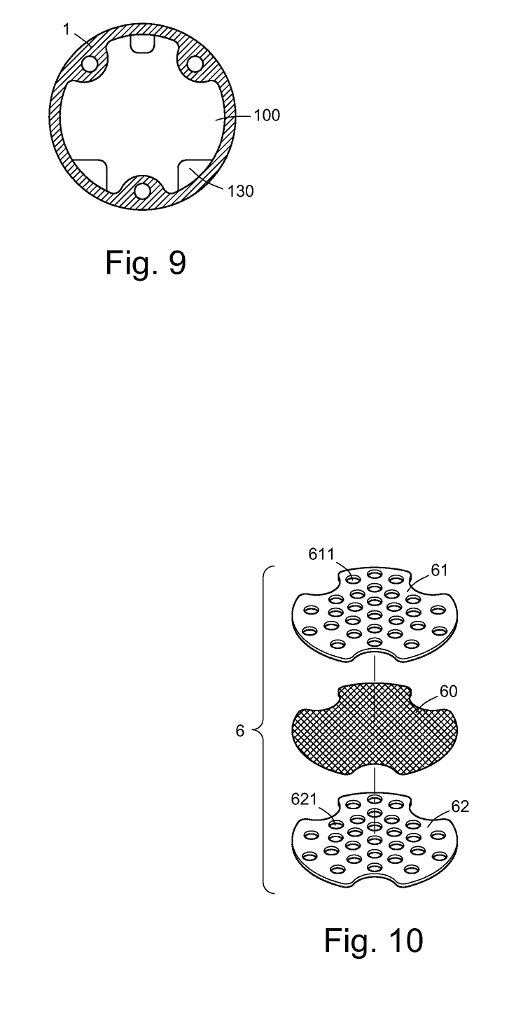

Still in another preferred embodiment, as shown in FIGS. 8 and 9, the filter 3 may be disposed in the air chamber 100 with a non-round cross section, such as the curved shape in FIG. 9. A cover 5 is fixed on the end of the handle 1 and has an air inlet 51 formed therein to connect the rear chamber 120. A curve-shaped connector 52 is extended from the cover 5 to be fixed in the air chamber 100 so that the filter 3 can be secured between a plurality of protruding ribs 130 and the connector 52. Meanwhile, an inner plate 61, an outer plate 62 and the filter element 60 of the filter 6 are formed in the curved shape as the cross section of the air chamber 100 and a plurality of through holes 611 and 621 are respectively formed on the inner and the outer plates 61 and 62. Therefore, same function as in the above-mentioned filter of the present invention can be achieved.

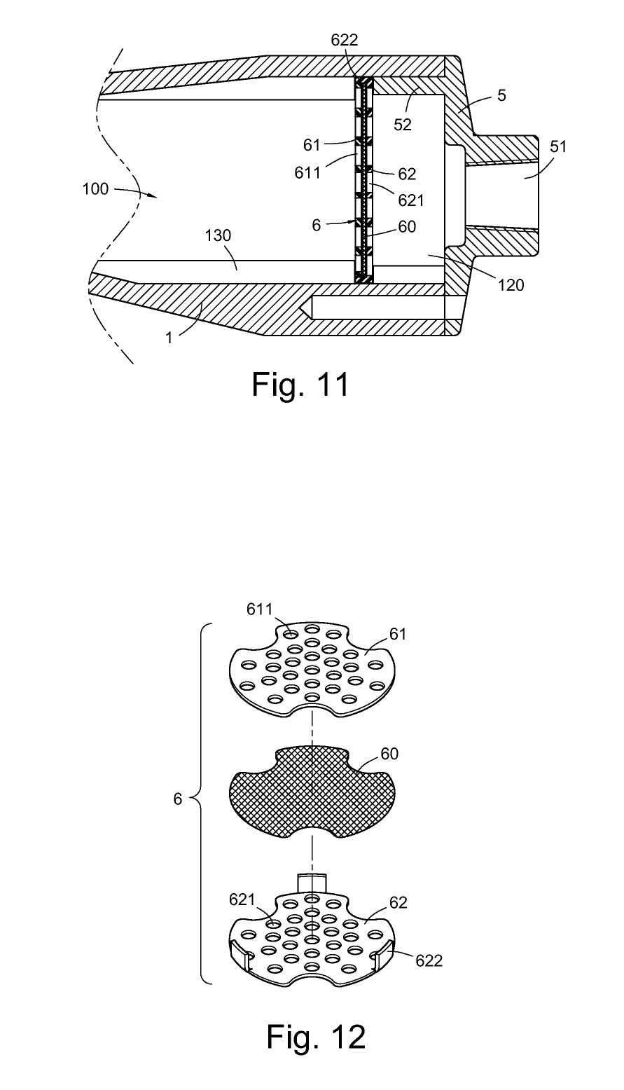

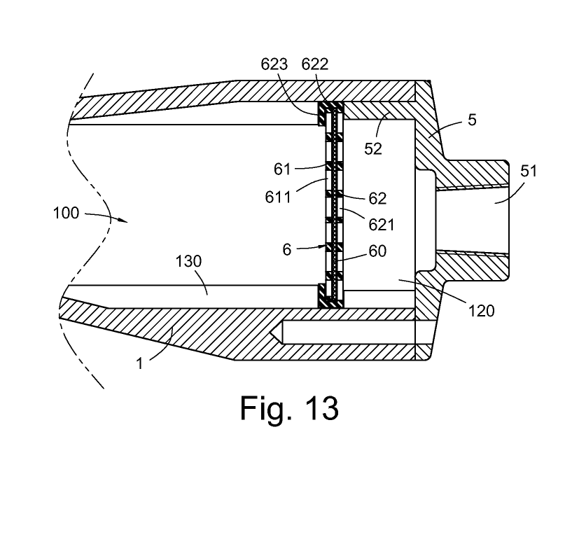

Similarly, as shown in FIGS. 11 and 12, a plurality of protrusions 622 may be formed on the edge of the outer plate 62 to combine with the filter element 60 and the inner plate 61 so that the filter element 60 can be prevented from distortion. Moreover, as shown in FIG. 13, a plurality of holding portions 623 are respectively extended from the protrusions 622 to securely rivet with the inner plate 61 to avoid the inner plate 61 from separation.

The above annular ring 322, protrusions 622 or holding portions 323 or 623 may be instead formed on the inner plate 31 or 61 to engage with the outer plate 32 or 62 without anything formed thereon, which is within the same scope of the present invention.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A filter for a nail gun, which is disposed inside an air chamber in a handle of the nail gun and located close to the end of the handle to divide the air chamber into a front chamber and a rear chamber, a cover with a connector extended therefrom being fixed on the end of the handle and a plurality of protruding ribs being formed on the inner wall of the front chamber, so that the filter is fixed between the protruding ribs and the connector, the filter comprising:
an inner plate formed with a plurality of first through holes, which is disposed adjacent to the front chamber;
an outer plate formed with a plurality of second through hole, which is disposed adjacent to the rear chamber and connected with the inner plate; and
at least one filter element fixed between the inner and the outer plates to filter particles of high pressure air introduced into the air chamber.

2. The filter for the nail gun as claimed in claim 1, wherein an annular ring or a plurality of protrusions are formed on edge of the inner or the outer plate to engage with the outer or the inner plate.

3. The filter for the nail gun as claimed in claim 2, wherein a holding portion is extended from the annular ring or each protrusion so that the inner and the outer plates are well engaged to securely fixed the filter element therebetween.
